(19) United States
(12) Patent Application Publication
(10) Pub. No.: US 2024/0080670 A1
(43) Pub. Date: Mar. 7, 2024

(54) METHOD FOR DETECTING A RELAY ATTACK

(71) Applicant: Lambda:4 Entwicklungen GmbH, Hamburg (DE)

(72) Inventor: Rönne REIMANN, Hamburg (DE)

(73) Assignee: Lambda:4 Entwicklungen GmbH, Hamburg (DE)

(21) Appl. No.: 18/250,883

(22) PCT Filed: Nov. 3, 2021
(86) PCT No.: PCT/EP2021/080524

§ 371 Date: Jun. 26, 2023

(30) Foreign Application Priority Data
Nov. 4, 2020 (WO) PCT/EP2020/081015

(51) Int. Cl. H04W 12/128; G01S 13/84

(52) U.S. Cl. CPC H04W 12/128; G01S 13/84

(57) ABSTRACT

The invention relates to a method for detecting and/or preventing relay attacks. The object is achieved by a method for detecting a relay attack, wherein radio signals at different frequencies are transmitted between a first and a second object and phase measurements and propagation time measurements are performed on these radio signals, and the change in the phase measurements for a change in the frequency is compared with the signal propagation measurements or their change, and, if a predetermined difference or a difference determined from measurements on the radio signals is exceeded, it is assumed that a relay attack is taking place.

### TECHNICAL FIELD

The invention relates to a method for detecting and/or preventing relay attacks.

### BACKGROUND ART

Numerous methods are known for detecting relay attacks or preventing, in particular man-in-the-middle or wrap-around-attack, or phase-manipulation-attack or early-detect-late-commit attacks.

These methods generally require complicated and expensive hardware. The problem which the invention seeks to solve is to enable a rapid and/or reliable detection of relay attacks.

Moreover, determining the phase position of a received position and comparing it to a phase position determined in another manner, and presuming a relay attack in the event a predetermined deviation is exceeded, is known from EP 3 564 703 A1. It thus discloses comparing a temporal position or phase position to a temporal position and/or phase position that is predetermined or calculated using other methods, and not comparison to a time-of-flight. Additionally, the temporal position is not a time-of-flight, but rather an equivalent to phase position.

### SUMMARY OF THE INVENTION

Surprisingly, it was established that the distances obtained from distance measurement are dependent upon the frequency used for the distance determination when standard commercial transceivers are used, such as the somewhat older cc2500 or the current cc26xx by Texas Instruments or the Kw35/36/37/38 by NXP or the Dialog DA1469x by Dialog.

It was also recognized that the measurement values obtained through phase measurement and time-of-flight measurements change consistently and nearly proportionally with the change in the frequency used for measurement. From this it was recognized that a deviation in the changes did not have a natural origin, and indicated a relay attack. It was recognized that for this purpose, it is not necessary to calculate the distances, but rather that measurement values could be compared with only little or no processing, and a relay attack could thus be easily and reliably recognized, which is preferred.

The problem is solved by a method for detecting a relay attack, wherein radio signals with different frequencies are transmitted between a first and a second object, and phase measurements and time-of-flight measurements (pulse time-of-flight measurements, ToF) are performed on them, wherein the span of the frequencies of the radio signals on which the time-of-flight measurements are performed and the span of the frequencies of the radio signals on which phase measurements are performed have an overlap in a frequency interval, in particular, they are equal, and in this frequency interval the change in phase measurements upon change of the frequency, or the change in phase shifts upon change of the frequency, is compared to the signal time-of-flight measurements, or their change upon change of the frequency is compared, and wherein a relay attack is presumed and/or an access or a release is denied, a requested act or action is not performed and/or an alarm or locking is performed, in the event that a deviation that is predetermined, or determined from measurements on the radio signals, is exceeded, in particular, by a value that is predetermined, or determined from the measurements on the radio signals, and/or wherein a relay attack is presumed not to be present and/or the access or the release is granted, the requested act or action is performed, and/or the alarm or locking is not performed, in the event that a deviation that is predetermined, or determined from measurements on the radio signals, is not reached, in particular, by a value that is predetermined, or determined from the measurements on the radio signals. In particular, a predetermined deviation exists at a value that corresponds to a distance difference of more than one meter, in particular, more than two meters, and/or less than five meters, in particular, less than three meters. It is not necessary for the comparison to be performed after conversion into distances, but rather the deviation can also be predetermined in other units that enable a comparison.

A conversion is also possible, in particular, using the relationship

Phase shift=2 Pi*(Distance)*Frequency/c, wherein it should be noted that beyond a determined distance, an ambiguity must be considered; and c equals the speed of light

RTT=2*Distance/c
and from that, disregarding the ambiguity: Phase shift=Pi*(RTT*c)*Frequency/c
and/or

dPhase shift(f1,f2)=Pi*(RTT*c)*dFrequency(f1,f2)/c
from this, it thus follows (again showing the ambiguity) that dPhase shift (f1,f2)RT/dFrequency(f1,f2)=Pi*RTT
it should be noted that ambiguity arises at distances greater than c/dFrequency. In most applications, however, the frequency spacings can be selected such that no ambiguities arise, at least at distances below 150 meters. In particular, the possible distance and/or the frequency difference dFrequency is/are selected such that no ambiguity arises or this can be disregarded. In particular, the distance is less than the speed of light divided by the frequency difference of the measurement of the phase shift, in particular, is less by at least half, in particular, less than 300 m, in particular, less than 150 m.

In this context, the phase shift (f1,f2)RT is a phase shift between the transmissions at the frequencies f1 and f2 from one object to the other, and back, which occurs as a result of the distance. It can be approximately equated with double the phase shift that occurs upon transmission from one object to the other as a result of the distance. dPhase shift (f1, f2) continues to be the, potentially corrected, distance-caused phase shift difference of the radio signals received at the frequency f1 and the frequency f2, and dFrequency is the difference between them, and c is the speed of light. RTT is the signal round-trip-time from one object to the other, and back. Instead of accepting the ambiguity problem, it is possible to resolve the ambiguity by other methods and to formulate the ambiguity by adding the ascertained correction terms in order to resolve the ambiguity.

The signal time-of-flight is determined, in particular, at one frequency or more frequencies, in the range of 90% f1 to 110% f2, wherein f1 is less than f2. In particular, f1, f2, and f3 are in the range from 1 GHz to 10 GHz, in particular, in the range from 2 MHz to 6 GHz, in particular, they are frequencies of a Bluetooth channel.

Especially preferred are embodiments in which a change of the phase measurements upon change of the frequency is compared to the signal time-of-flight measurement, and/or in which a change of the phase shift upon change of the frequency, in particular relative to the change in frequency, is compared to the signal time-of-flight measurement, wherein the change of the phase shift arises on the basis of the distance. Or expressed differently, it is especially preferred for change of the phase measurements, or in particular, distance-caused phase shifts, to be compared with the signal time-of-flight measurements upon change in the frequency, and for this comparison to be performed, and checked, for various frequencies, whether these comparisons result in comparison values that fall within a span that is predetermined, or determined from measurements on the radio signals, or which exceed a deviation that is predetermined, or determined from the measurements on the radio signals, in particular by a value that is predetermined, or determined from measurements on the radio signals. In particular, if the comparison values fall outside the span or the interval, or if the deviation is exceeded, a relay attack is presumed to be detected and/or otherwise it is concluded that no relay attack is present.

The change in phase shift caused by, or the change in phase shift arising as a result of, the frequency change is caused in that, particularly when both measurements are at approximately equal distance, a different number of wave packets fit within the distance and consequently the phase shift, which is caused by the distance, ends up being different between the frequencies. This change in the phase shift as a result of the frequency is the phase change caused by the frequency change. In this context, problems result during measuring since in each case, the phase measurement is dependent on a reference, and a, frequently undefined, phase jump can result when switching over to transmit the various frequencies. Switching over for transmitting, and particularly also for receiving, is thus preferably done phase-coherently, i.e., with a phase jump of zero. But determining or knowing the phase jump is also sufficient. Then one can determine the phase change by the frequency change, through the measured phase change corrected by the phase jump upon switchover of the transmitter, and the phase jump upon switchover at the receiver for measuring the measured phase change.

The comparison can take place as follows, in that a comparison coefficient k is ascertained, and it is checked whether this lies in a predetermined span as a predetermined deviation.

dPhase shift(f1,f2)/dFrequency(f1,f2)/RTT=k

This is not preferred, however; rather, it is rather preferred to work without forming a ratio, rather to ascertain a difference, and to check whether this lies in a predetermined span as a predetermined deviation, i.e., for example to build the difference between the measurement signal time-of-flight (pulse signal time-of-flight, ToF) (in only one direction, i.e., approx. 0.5 RTT) and the term

dPhase shift(f1,f2)/dFrequency(f1,f2)/2/Pi
and to check whether the result lies in a predetermined span. Of course, differences can also be formed between similar expressions, such as between

RTT×Pi and dPhase shift(f1,f2)/dFrequency(f1,f2)

This is done, in particular, such that the change between the received phase positions, said phase positions having been corrected by the phase changes arising upon emission, is determined at two frequencies, in particular, adjacent frequencies, particularly with a frequency difference of less than 5%, in particular, less than 1%, of the lowest frequency, and/or less than 10 MHz, in particular, less than 9 MHz, in particular, less than 2 MHz, and their ratio is compared to the signal time-of-flight, for example at one of the frequencies, or averaged signal time-of-flight of both frequencies, or to the signal time-of-flight at a similar frequency, in particular, with a frequency difference of less than 5%, in particular, less than 1%, of the lower frequency, and/or less than 17 MHz, in particular, less than 10 MHz, in particular, less than 9 MHz, in particular, less than 2 MHz, or similar. In particular, this can take place by forming a ratio. Furthermore, this can be scaled through division by the frequency difference of the frequencies of the phase measurements. If this is repeated for multiple frequency pairs of the phase measurement, fluctuations result, which to deny a relay attack must lie within a predetermined interval or an interval determined from measurements on the radio signals. This can be formulated thus, for example:

For signal flight in one direction only:

Delta_Phase shift(f1->f2)/Delta_Frequency(f1->f2)/signal time-of-flight(f3˜f1∥f2)=X(f1f2f3)(disregarding the ambiguity)

or

Delta_Phase shift(f1->f2)/Delta_Frequency(f1->f2)−2×Pi×signal time-of-flight(f3˜f1|f2)=X(f1f2f3)(disregarding the ambiguity)

or

Delta_Phase shift(f1->f2)/Delta_Frequency(f1->f2)+ambiguity correction—2×Pi×signal time-of-flight(f3˜f1|f2)=X(f1f2f3)

For signal round-trip:

Delta_Phase shift(f1->f2)/Delta_Frequency(f1->f2)/signal round-trip-time(f3˜f1|f2)=X(f1f2f3)(disregarding the ambiguity)

or

Delta_Phase shift(f1->f2)/Delta_Frequency(f1->f2)−Pi×signal round-trip—Time(f3˜f1|f2)=X(f1f2f3)(disregarding the ambiguity)

or

Delta_Phase shift(f1->f2)/Delta_Frequency(f1->f2)+ambiguity correction−Pi×signal round-trip-time(f3˜f1|f2)=X(f1f2f3)

In this context, Delta_Phase shift(f1->f2) is the, potentially corrected (by the phase changes arising upon the emission), distance-caused phase shift difference of the radio signals received at the frequency f1 and the frequency f2, and Delta_Frequency(f1->f2) is the difference between the frequencies f1 and f2, and the signal time-of-flight(f3˜f1|f2) is the one-way signal time-of-flight between the objects at a frequency similar to f1 or f2, wherein, in particular, frequencies considered similar are all frequencies that have a lower deviation than plus or minus 5%, in particular, less than plus minus 2%, in particular, less than plus minus 1%, in particular, less than plus minus 0.4%, of f1 or f2, and/or less than 17 MHz, in particular, less than 10 MHz, in particular, less than 2 MHz. A deviation in the range from plus minus Y is understood, in particular, as a deviation in the range from −Y to +Y. X(f1f2f3) thus represents the comparison value for the frequency triplet f1, f2 f3, which to deny a relay attack must lie within an interval that is predetermined, or determined from the measurements on the radio signals, or a relay attack is presumed in the event its position is outside of the interval. The interval can be given by deviation from a value. The smaller the differences between f1, f2, and f3 are in X(f1f2f3), the more accurately the method is performed, provided the means used are capable of sufficiently resolving the differences due to the spacing of f1 and f2. The more different frequency triplets are tested and the greater their spacing in the frequency band (with frequencies f1, f2, and f3 as similar as possible (provided the means used are capable of sufficiently resolving the differences)), the more reliable the detection is. It has proven effective in practice to select the difference between the frequencies f1 and f2 at at least 0.1 MHz. f3 can also be equal to f1 or f2. Signals of the phase measurement can be reused for the time-of-flight measurement, such that advantageously f3 is equal to f1 or f2, or two signal times-of-flight at f1 and f2 are used, and these are averaged, for example. These can then be regarded as signal time-of-flight (f3=(f1+f2)/2).

A correction of the phase measurement at the receiver is advantageous particularly when phase-coherent frequency switching without phase jump is not performed at the transmitter and/or receiver. This is because it does not depend on the phase measured on reception as such, but rather on the phase change caused by the distance. Thus the two phase shifts at f1 and f2 caused by the transmission preferably go into Delta_Phase change(f1->f2).

But other comparisons are also possible, provided they compare the change in phase shift of the radio signal upon the frequency change to the signal time-of-flight, and this occurs at multiple frequencies or frequency triplets. Thus, distances can also be calculated and compared.

It is also possible to neutralize movement effects, for example through multiple measurements time-staggered at a same frequency, in particular in that the phase measurements are averaged.

Advantageously, the frequencies of the radio signals on which time-of-flight measurements are performed, and frequencies of the radio signals on which phase measurements are performed, differ only insubstantially, in particular, the time-of-flight measurements and phase measurements are performed on the same radio signals. In particular, for at least half of the frequencies of the radio signals on which time-of-flight measurements are performed, there is at least one radio signal, which can also be the same one, that has a frequency with a deviation of less than 5% on which a phase measurement is performed and/or for at least half of the frequencies of the radio signals on which phase measurements are performed, there is at least one radio signal, which can also be the same one, that has a frequency with a deviation of less than 5% on which a time-of-flight measurement is performed. An especially reliable detection is possible in such an embodiment.

Preferably, the method is conducted such that the radio signals comprise a first plurality of radio signals, and a second plurality of phase measurements and a third plurality of signal time-of-flight measurements are performed, wherein the second plurality of signal time-of-flight measurements is carried out on a fourth plurality of signals with a fifth plurality of frequencies, and the third plurality of signal time-of-flight measurements is carried out on a sixth plurality of signals with a seventh plurality of frequencies, and the span of the fifth plurality of frequencies and the span of the seventh plurality of frequencies have an overlap in the frequency interval, and in this frequency interval the change of the second plurality of signal time-of-flight measurements is compared to the change in the third plurality of signal time-of-flight measurements, or to the change. An especially reliable detection is also possible in such an embodiment. The third plurality is particularly in the range from 10 to 150, and the second plurality is particularly in the range 10 to 300. Phase measurement pairs are ascertained in the range 10 to 150, in particular. Phase measurements that are adjacent, particularly with regard to the frequency, can be regarded as pairs, wherein the pairs can be structured such that phase measurements are part of two pairs.

The frequencies at which the time-of-flight and/or phase measurements are performed lie particularly in a span from 25 to 100 MHz, in particular they completely span such a span. The frequencies lie particularly in the range from 2 to 6 GHz. A spacing in the range from 0.1 to 10 MHz, particularly in the range from 0.5 to 10 MHz, lies particularly between adjacent frequencies used for the time-of-flight and/or phase measurements.

In each case, in particular, a time-of-flight measurement at the frequency Fl is compared to a phase shift between the frequencies Fa and Fb, wherein Fa<=Fb, in particular, and

Fa−10 MHz<=Fl<=Fa+10 MHz and/or F1<=Fl<=F2

In particular, also Fa—10 MHz<=Fb<=Fa+10 MHz

The predetermined deviation or span can be constant, or, for example, can depend on the frequencies, for example the sum or the mean of the frequencies f1, f2, f3 or fa, fb, f1.

Multiple comparisons can also be performed and an aggregate comparison number can be determined, which is compared to a predetermined deviation. For example, the mean value of the deviation can be formed and this can be compared to a predetermined deviation. It is also possible to sum the magnitude of by which a predetermined deviation is exceeded and the magnitude by which a value is not reached or not exhausted with reversed signs, and to compare to a predetermined sum deviation. Unequal weightings in an aggregation are also conceivable.

Especially advantageously, the phase-based measurements and/or time-of-flight measurements are used for distance measurement, this allows other attacks to be detected, other functions to be implemented, and the radio signals to be used efficiently.

Preferably, the signal times-of-flight and/or signal time-of-flight changes are compared to the change in phase positions and/or phase position changes.

Preferably, the number of the phase measurements and/or the time-of-flight measurements performed in the frequency interval, and/or the number of frequencies on which phase measurements and/or time-of-flight measurements are performed in the frequency interval is selected at least as five.

Advantageously, the method is carried out with multiple first objects and a common second object. In particular, the common second object can be an authentication means, such as an electronic key, for example, a key fob. This augments the reliability of the detection and makes it more difficult to deceive the system.

Preferably, the signal time-of-flight measurements and the phase measurements are simultaneous, in particular, those performed at similar frequencies or those set in ratio are performed within 100 ms, in particular, within 10 ms, and/or on the same radio signals. This augments the accuracy and robustness despite movement and environmental influences. The measurements can be carried out at different frequencies with a larger time interval.

Especially preferably, the second plurality is selected equal to the third plurality, and/or the fourth plurality is selected equal to the sixth plurality, and/or the fifth plurality is selected equal to the seventh plurality, and/or the fourth plurality of radio signals is selected equal to the sixth plurality of radio signals, and/or the fifth plurality of frequencies is selected equal to the seventh plurality of frequencies.

One radio signal is delineated from another, in particular, in that it has another frequency. In particular, radio signals have frequency differences among themselves that are larger than the frequency stability of the involved hardware.

Further advantageously, in particular, to simplify the comparisons and design them even more robustly, the change is carried out phase coherently between at least two, in particular, all, of the fifth plurality of frequencies, and/or between at least two, in particular, all, of the seventh plurality of frequencies. Preferably, all frequency changes of at least one of the objects are performed phase-coherently. Somewhat less advantageously, but still advantageously, the phase shifts arising upon frequency change are measured, in particular, at the transmitter and/or receiver, and used for correction of the phase measurements.

Advantageously, the method is conducted such that time-of-flight measurements and/or phase measurements on radio signals, and/or radio signals with a power below a lower power limit of received radio signals that is predetermined and/or ascertained, in particular from or in consideration of received radio signals, are not taken into consideration, in particular, those radio signals that lie more than 50% below the mean power of the received radio signals are not considered, and/or wherein time-of-flight measurements and/or phase measurements on radio signals, and/or radio signals with a power above an upper power limit of received radio signals that is predetermined and/or ascertained, in particular from or in consideration of received radio signals, are not taken into consideration, in particular, those radio signals that lie more than 50% above the mean power of the received radio signals are not considered.

In other words, it is preferred when the measurements with low received power, in particular, a received power below a predetermined value or proportion of the average or maximum received power, are not taken into consideration and/or the measurements with very high received power, in particular, a received power above a predetermined value or proportion of the average or maximum received power, are not taken into consideration. The method can be embodied especially robustly by such embodiments.

Preferably the breadth of the frequency interval is at least 0.1 MHz and/or a maximum of 100 MHz, and/or the frequency spacing between two consecutive frequencies of the different frequencies is at least 0.1 MHz and/or a maximum of 10 MHz, and/or it is preferred when the different frequencies are at least five frequencies and/or a maximum of 200 frequencies, and/or wherein the radio signals are emitted at the different frequencies successively and/or consecutively, in particular, directly consecutively, and/or wherein at no time the bandwidth of the radio signals exceeds 50 MHz, in particular, 25 MHz.

Especially advantageously, the method is applied combined with another invention. Thus two objects are or will be time- and/or clock-cycle-synchronized to preferably 10 ns or better, and the first and/or second of the two objects emits the radio signals at multiple frequencies, and the second and/or first of the two objects receives these signals, wherein only the signals of the first object or the signals of the second object are used for detecting a relay attack, and the method contains the decision as to whether the signals of the first and/or of the second object are used, in particular, the decision resting in each case on the basis of an estimate or determination of effects of interferences on the reception at both objects.

Synchronizing timers in two objects is known, both via cabled and wireless connections. For example, there is the NTP protocol. Within the scope of a Bluetooth connection, too, a synchronization is provided in which each object has a freely running 28-bit clock with a cycle of 3.2 kHz and each object ascertains its offset relative to a central clock, and corrects the offset on a regular basis. In this case, synchronization with an accuracy of approximately 125 ns is achieved. Improved time synchronization is also known, for example, from DE1 1 201 4004426T5 or “Synchronization in radio Sensor Networks Using Bluetooth,” Casas et al., Third International Workshop on Intelligent Solutions in Embedded Systems, 2005, ISBN: 3-90246303-1. This can be used for saving energy, for example, in that an object is kept ready to receive only in certain time slices, which are known to the other object, in order to send at corresponding times. Synchronization of the clocks is also still possible, at least with one-sided relatively strong interference on the radio channel, although the distance measurement becomes impossible or very inaccurate, or takes a very long time during such interference. However, synchronization to a clock-cycle of a received signal at the receiver of the signal must be clearly differentiated from the accuracy of a time synchronization. In this case, there is no synchronization of two clocks at two objects, but rather the receiving object is set such that it is synchronized with the incoming signal. The signal time-of-flight does not play a role here, since for that it is irrelevant when the signal was sent and/or how long it took to be transmitted.

Thus only the first object can transmit and the second object can receive the signals of the first object, or the second object can transmit and the first object can receive the signals of the second object. Both can also be combined with one another, in particular temporally successively or alternatingly.

Performing the method in such a manner helps to speed up the determination of the distance and/or to increase the accuracy of the determination of the distance between two objects, including in the event of reception interference at one of the two objects. Since for that purpose, it can be desirable to carry out the distance determination largely without consideration of the radio signals of one transmission direction. Surprisingly, the inventor has identified that it is possible to not consider one transmission direction between time- and/or clock-cycle-synchronized objects, particularly with phase-coherent frequency change. This ensures a more rapid measurement, since the switching times of the transceivers can also be largely disregarded, and enables the distance to be determined even in the event of strong one-sided interference on the radio channel.

An embodiment of the invention is characterized in that only the signals transmitted by the first object, or (exclusive or) the signals transmitted by the second object, are used for determining the relay attack.

Embodiments are possible in which, for distance determination, only the first object transmits as well as those in which, for distance determination, only the second object transmits, and embodiments are possible in which, for distance determination, both transmit, but only part of the signals, namely those transmitted from the first object or (exclusive or) those transmitted by the second object.

The method preferably contains the decision as to whether the signals of the first or of the second object will be used, the decision resting in each case in particular on the basis of at least one estimate or determination of effects of interferences on the reception at both objects. This decision can be made before or after the transmission of the signals, or after the transmission of a part.

Insofar as the speed is to be increased, it is preferred to make the decision as early as possible and to keep the transmission of non-used signals as little as possible, in particular, not to send any more such signals after the decision. If the method is to be embodied in a manner minimally prone to interference, the decision is made only after transmission of the signals of the first object and of the signals of the second object.

Transmitted and received signals can be used for making the decision. However, alternatively or additionally, other data or measurements can also be used, such as noise or non-method-signals at the receiver.

Selected are, in particular, the radio signals of the first or (exclusive or) of the second object, the reception of which at the respectively other of the two objects was, is, or is foreseen to be, subject to less interference.

Especially advantageously, the first and/or the second object changes between at least two of the multiple frequencies phase-coherently, or a phase jump arising upon switching at the switching object is measured and is considered in the calculation. An even robuster and simpler performance of the method, but also distance measurement, can be implemented thereby, and additional advantages in the use of the signals can be realized in that evaluations based thereupon are simplified. For example, when the point in time of the phase-coherent change or of the change with measured phase jump at the transmitting object is known, and when the change in the received signal is determined at the received object, the time between transmitting and receiving the change is determined, which time represents the signal time-of-flight (ToF), and the phase shift is also determined. The distance can be directly determined from the signal time-of-flight using the speed of light. This, however, is likewise possible modulo the wavelength by using the phase shift. The ambiguity accompanying the phase-based measurement can be reduced by using multiple frequencies. A particularly accurate and robust distance measurement can be realized by combining the signal time-of-flight measurements and phase-based measurements.

Phase-coherent switching or changing between two frequencies is understood to mean, particularly, that the time-point of the switching is determined exactly or is measured, and the phase after the switching is known relative to the phase position before the switching. This is the case when the change of phase when switching is zero, or is equivalent to a previously known value. Alternatively, the phase jump arising upon switchover can also be measured, in particular locally, i.e., before the transmission and, respectively, relating to the reception at the receiver and can be calculated out, and/or corrected, before and/or during the comparison.

The phase difference or phase jump at the change between frequencies can be known, for example, in that it is predetermined or can be derived from other known values, for example, the duration of a, particularly directly, preceding, emission at a frequency.

The phase difference when switching between two frequencies generally arises due to technical reasons, but can also be prevented. The switching between two frequencies can be carried out with a short interruption or interruption-free. At the time of the interruption-free change, the phase jumps, or during the change with interruption, the phase of the signals theoretically imagined to continue during the interruption, jumps before and after switching. A defined phase jump exists at the change time-point without interruption, or at a theoretical change time-point during the interruption, particularly in the middle of the interruption and/or at the end of the signal before the interruption or at the beginning of the signal after the interruption. This is the phase difference.

Especially advantageously, switching is done phase-coherently, including at the receiving object and/or for receiving, in particular between the different frequencies. Thus, in particular, the first and second object switch phase-coherently between frequencies. This occurs in particular by phase-coherent switching of at least one PLL at the first and/or second object. In particular, the objects are configured accordingly.

Moreover, surprisingly, it was established that the distances obtained from the one-sided distance measurement according to the invention described here are not only dependent upon the frequency used for the distance determination when standard commercial transceivers are used, such as the somewhat older cc2500 or the current cc26xx by Texas Instruments or the Kw35/36/37/38 by NXP or the DA1469x by Dialog, but rather can result in calculated distances that are less than the actual distance, but only with those frequencies whose transmission channel is highly attenuated, such that these can be eliminated from the calculation without issue

It is thus advantageous in performing the method to not use part of the radio signals with different frequencies, namely, not to use those components that lie below a lower power limit.

It has also been shown not to use such components as lie above an upper power limit.

These limits can be predetermined, or can be determined based on the received signals, and particularly can be above or below the mean received power, and can be particularly at least 20% above the mean received power (upper power limit) and/or at least 20% below the mean received power (lower power limit).

Preferably, not taken into account are signal components at frequencies received with less than 40%, or at least signals received with less than 20%, particularly less than 40%, of the mean energy of the signals, and/or signals received with greater than 140%, particularly with greater than 120% of the mean energy.

Advantageously, the lower power limit lies in the range from 5 to 50% of the mean power of the received signals, and/or the upper lower limit lies in the range from 120 to 200% of the mean power of the received signals.

In another embodiment, the x % of the signals with the smallest received amplitude are sorted out and not used, and/or the y % of the signals with the largest received amplitude are sorted out and not used. It has been shown to be especially advantageous when the sum of x and y does not exceed 10, and/or does not fall below 75, and/or x lies in the range from 10 to 75, and/or y lies in the range from 20 to 50. In most situations, a high degree of accuracy and a reliable detection can be achieved with these values.

Advantageously, the second or (exclusive or) first object does not transmit any signals for distance determination, and/or the second or the first object (exclusive or) only transmits signals for time- and/or clock-cycle synchronization. This saves energy and method time.

Preferably the first and/or second, or each of the two objects, sends the signals on multiple frequencies successively and/or consecutively, in particular directly consecutively. In particular, when sending is taking place by the first and second object, all signals of the first or of the second object are sent first, then those of the other. Influences of environmental or distance changes, and of movements of one or both objects, can be thus reduced.

Advantageously, at no time does the bandwidth of the signals exceed 50 MHz, particularly 25 MHz. Consequently energy can be saved, interference with other processes can be prevented, and simple components can be used compared to broadband methods.

Preferably, a time- and/or clock-cycle synchronization and/or correction is carried out between the two objects before, after and/or while the method is carried out. This augments the accuracy of the method. Preferably, a drift of the clock of the first and/or second object, or a difference in the drift of the clock of the first and of the second object, is also determined and considered in the distance determination. This augments the accuracy of the method.

Advantageously, the signals are transmitted over multiple antenna paths, particularly with multiple antennas, particularly successively, transmitted at the transmitting object, and/or received at the receiving object, with multiple antennas.

Especially advantageously, upon detection of a relay attack, an access or a release is denied, a requested act or action is not performed, and/or an alarm or locking is performed, and/or upon non-detection of a relay attack, the access or the release is granted, and/or the requested act or action is performed, and/or the alarm or locking is not performed.

The problem is also solved by one or two objects, each of which is configured with transmission and receiving means, and a controller, configured for carrying out the method according to the invention.

Advantageously, the objects are parts of a data transmission system, particularly a Bluetooth, WLAN, or radio, data transmission system. Preferably, the radio signals are signals of the data transmission system, particularly of a data transmission standard, for example a radio standard, WLAN, or Bluetooth, which signals are used for data transmission according to the data transmission standard.

The problem is also solved by the use of the change of phase measurements compared to signal time-of-flight measurements, or their change between two objects, for detecting a relay attack, wherein the phase measurements and signal time-of-flight measurements are performed on signals with overlapped frequency bandwidths.

The problem is also solved by an access system for granting and/or denying an access, configured for carrying out the method according to the invention and for granting and/or denying based on the detection according to the method.

The evaluation is done as follows, for example:

For two frequencies f1 and f2 lying closely next to one another, e.g., 2410 MHz and 2411 MHz, in each case the phase sum is determined for the transmission from the first object to the second object, and back to the first object.

Then the difference of these phase sums divided by the difference between the two frequencies is directly proportional to the distance required by the radio signal for the outbound and return path, and thus also to the signal time-of-flight.

If a ToF measurement is now in each case also to be performed at both frequencies, the time at both frequencies will not differ much or is even equal, and is also directly proportional to the distance required by the radio signal for the outbound and return path. Thus this signal time-of-flight can be compared to the phase change, in particular, divided by the frequency difference, for example set in ratio, and it can be checked whether this ratio lies in a, or outside of a, predetermined or determined interval.

However, it is also possible to determine the distance based on the time-of-flight and based on the phase difference, and if this has more than a predetermined or determined deviation, to regard a relay attack as detected, for example, when the calculated distances differ from one another by 2 m or more.

In this example, an additional phase difference can be obtained, for example, by switching back to the first frequency, said additional phase difference containing the movement with the same proportion, but the distance with negative sign. The movement is eliminated by subtracting both phase differences and dividing by two. This result, like the original measurement, can then be used again for further work steps.

### BRIEF DESCRIPTION OF THE DRAWINGS

The drawings illustrate a possible embodiment of the invention purely schematically and in a non-limiting manner.

FIG. 1 shows schematically the phase of a radio signal transmitted from a first object to a second object over the time at the respective object.

FIG. 2 shows schematically values for X plotted against a desired axis, for example, a time axis or an axis that indicates the sum or the mean of the frequencies f1, f2, f3.

### DETAILED DESCRIPTION

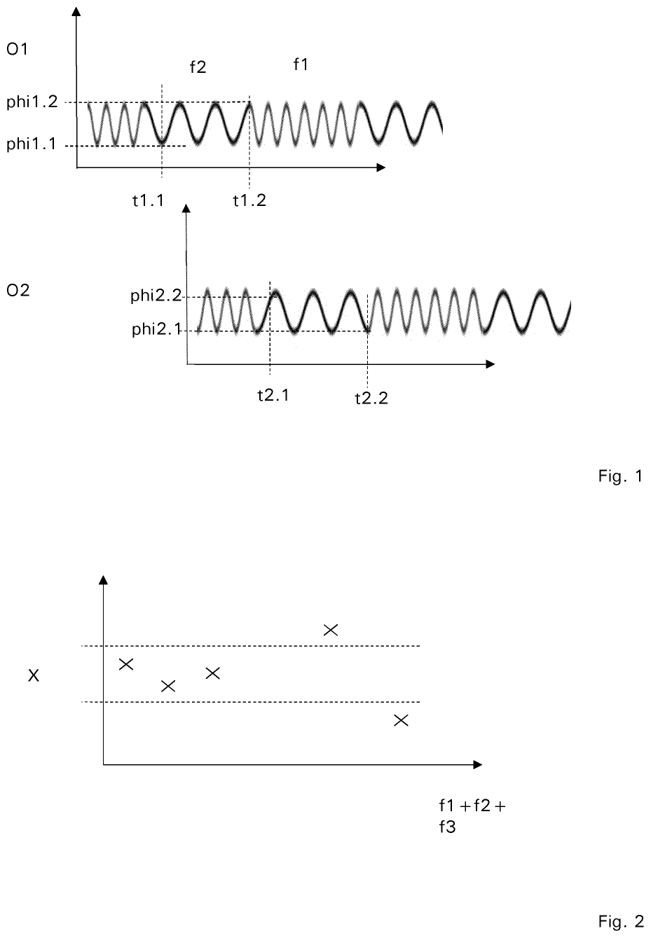

FIG. 1 shows, in each case for the two objects 01 and 02, the phase of the radio signal transmitted from object 01 to object 02 over the time at the respective object. An illustration of a continuous sine wave with phase-coherent frequency change, without phase jump, which is transmitted from object 1 to object 2, is shown. If the phases phi1.1 and phi 1.2 are determined at the first object or if these are known and this also applies to the times of the frequency change t1.1 and t1.2, and if the time delay between the clocks of the objects 01 and 02, t1 and t2 is known, and if the time points of the reception of the frequency change t2.1 and t2.2 and the then present phases phi2.1 and ph2.2 are determined, the above-described calculations can be easily done using the frequencies f1 and f2, and for example X(f1f2f3) can be determined, for example, using f3=f1.

FIG. 2 shows such values for X plotted against a desired axis, for example, a time axis or an axis that indicates the sum or the mean of the frequencies f1, f2, f3. An interval is also indicated by a dashed line. If X lies in the interval, no relay attack is detected, if X deviates from this interval, a relay attack is detected, which is the case for the two values to the right for X.

1. A method for detecting a relay attack, wherein radio signals with different frequencies are transmitted between a first object and a second object, and phase measurements are performed on the radio signals with different frequencies
wherein the phase measurements are compared to a reference, and wherein a relay attack is presumed or an access or a release is denied, or a requested act or action is not performed, or an alarm or locking is performed, if a deviation is exceeded, where the deviation is predetermined or is determined from the phase measurements on the radio signals; or
wherein a relay attack is presumed not to be present or the access or the release is granted or the requested act or action is performed, or the alarm or locking is not performed, in the event that a deviation is not reached, where the deviation is predetermined or is determined from the phase measurements on the radio signals; and
wherein at least one signal time-of-flight measurement is also performed on the radio signals, and in that the change of the phase measurements between different of the frequencies is compared to the at least one signal time-of-flight measurement, or their change, as reference.

2. The method according to claim 1, wherein a span of the frequencies of the radio signals on which the at least one signal time-of-flight measurement are performed have an overlap in a frequency interval, and in the frequency interval, the change of the phase measurements is compared to the at least one signal time-of-flight measurement, or their change, as reference.

3. The method according to claim 1;
wherein the radio signals comprise a first plurality of radio signals, and a second plurality of phase measurements and a third plurality of signal time-of-flight measurements are performed, wherein the second plurality of phase measurements is carried out on a fourth plurality of signals with a fifth plurality of frequencies, and the third plurality of signal time-of-flight measurements is carried out on a sixth plurality of signals with a seventh plurality of frequencies, and a span of the fifth plurality of frequencies and a span of the seventh plurality of frequencies have an overlap in frequency interval, and in the frequency interval the change of the second plurality of phase measurements is compared to a change in the third plurality of signal time-of-flight measurements, or to the change in the at least one signal time-of-flight measurement performed on the first plurality of radio signals.

4. The method according to claim 3, wherein the second plurality is equal to the third plurality, and/or the fourth plurality is equal to the sixth plurality, and/or the fifth plurality is equal to the seventh plurality, and/or the fourth plurality of radio signals is equal to the sixth plurality of radio signals, and/or the fifth plurality of frequencies is equal to the seventh plurality of frequencies, and/or wherein the second plurality of phase measurements and the third plurality of signal time-of-flight measurements are performed on the same of the first plurality of radio signals, and/or wherein the second plurality of phase measurements and the third plurality of signal time-of-flight measurements are performed on the first plurality of radio signals, wherein, particularly in each case, a group made of a phase difference measurement determined from the second plurality of phase measurements and a signal time-of-flight measurement or signal time-of-flight-change measurement of the, or determined from the, third plurality, is used for the comparison, wherein the frequencies of the radio signals on which the measurements of a group are performed have among themselves a deviation of less than 5%.

5. The method according to claim 1, wherein from two phase measurements in each case at different frequencies a first distance between the first object and the second object, or a first value proportional to the distance between the first object and the second object, is determined, and from the at least one signal time-of-flight measurement a second distance or a second value proportional to the distance between the first object and the second object, is determined, and the difference between the first distance and the second distance, or the difference between the first value and the second value, is determined, wherein the proportionality of the first value and of the second value are equal or the distance between the first object and the second object is ascertained from the first value and the second value by a same arithmetic operation in each case.

6. The method according to claim 1, wherein phase-based measurements or signal time-of-flight measurements are used for distance measurement, or wherein the signal time-of-flight or signal time-of-flight changes are compared to a change in phase positions or a change in phase position changes.

7. The method according to claim 1, wherein a number of the phase measurements or the signal time-of-flight measurements performed in the frequency interval, or a number of frequencies on which phase measurements or signal time-of-flight measurements performed in the frequency interval is at least five.

8. The method according to claim 3, wherein the change between at least two of the fifth plurality of frequencies, or between at least two of the seventh plurality of frequencies, is done phase-coherently, or the phase shift arising upon the frequency change is measured and used for correcting the phase measurements.

9. The method according to claim 1, wherein signal time-of-flight measurements or phase measurements on radio signals, or radio signals with a power below a lower power limit of received radio signals that is predetermined or ascertained are not taken into consideration or wherein signal time-of-flight measurements or phase measurements on radio signals, or radio signals with a power above an upper power limit of received radio signals that is predetermined or ascertained are not taken into consideration.

10. The method according to claim 1, wherein of the phase and signal time-of-flight measurements performed, such measurements with received power below a predetermined value or proportion of the average or maximum received power, are not taken into consideration.

11. The method according to claim 1, wherein a breadth of the frequency interval is at least 0.1 MHz or a maximum of 100 MHz or both, or wherein a frequency spacing between two consecutive frequencies of the different frequencies is at least 0.1 MHz or a maximum of 10 MHz or both.

12. The method according to claim 1, wherein the first object and the second object are or will be time- or clock-cycle-synchronized to 10 ns or better, and wherein one or both of the first object and the second object emits the signals at multiple frequencies, and the one or both of the second object and the first object receives these signals, wherein only the signals of the first object or the signals of the second object are used for detecting a relay attack, and the method include a decision as to whether the signals of the first object or of the second object are used.

13. A use of the change of phase measurements compared to signal time-of-flight measurements or their change between two objects, wherein the phase measurements and the signal time-of-flight measurements are performed on signals with overlapped frequency bandwidths for detecting a relay attack.

14. An access system for granting or denying an access, configured for carrying out a method for detecting a relay attack, wherein radio signals with different frequencies are transmitted between a first object and a second object, and phase measurements are performed on the radio signals, and wherein the phase measurements are compared to a reference, and wherein a relay attack is presumed when an access or a release is denied, a requested act or action is not performed, or an alarm or locking is performed, or if a deviation that is predetermined or is determined from measurements on the radio signals, is exceeded, or wherein a relay attack is presumed not to be present when and said access system is configured for granting the access or the release or performing the requested act or action or not performing the alarm or locking, or when, in the event that a deviation that is predetermined or determined from measurements on the radio signals, is not reached; and wherein the access system is configured for performing at least one signal time-of-flight measurement on the radio signals, and in that the access system is configured for comparing the change of the phase measurements between different frequencies among the frequencies to the at least one signal time-of-flight measurement, or their change, as reference.

15. The access system according to claim 14, configured for determining from two phase measurements in each case a first distance between the first object and the second object, or a first value proportional to the distance between the first object and the second object, and for determining from the time-of-flight measurement a second distance between the first object and the second object, or for determining a second value proportional to the distance between the first object and the second object, and for determining the difference between the first distance and the second distance, or the difference between the first value and the second value.

16. The method according to claim 1, wherein the change of the phase measurements between different of the frequencies relative to the frequency change of the frequencies is compared to the at least one signal time-of-flight measurement, or their change, as reference.

17. The method according to claim 1, wherein the method is carried out with multiple first objects and a common second object.

18. The method according to claim 1, wherein the signal time-of-flight measurements and the phase measurements are performed simultaneously or within 100 ms, or on the same radio signals, or wherein the radio signals are emitted at the different frequencies successively or consecutively.

19. The method according to claim 18, wherein the signal time-of-flight measurements and the phase measurements are performed simultaneously or within 10 ms.

20. The method according to claim 1, wherein the different frequencies are at least five frequencies or a maximum of two hundred frequencies, or at least five frequencies and a maximum of two hundred frequencies, or wherein at no time does the bandwidth of the radio signals exceed 50 MHz.
